(19) United States
(12) Patent Application Publication
(10) Pub. No.: US 2011/0025727 A1
(43) Pub. Date: Feb. 3, 2011

(54) MICROSTRUCTURES FOR LIGHT GUIDE ILLUMINATION

(75) Inventors: Zhengwu Li, Milpitas, CA (US); Marek Mienko, San Jose, CA (US); Lai Wang, Milpitas, CA (US); Kollengode S. Narayanan, Cupertino, CA (US); Ion Bita, San Jose, CA (US); Kebin Li, Fremont, CA (US); Ye Yin, San Jose, CA (US); Russell Wayne Gruhlke, Milpitas, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS TECHNOLOGIES, INC., San Diego, CA (US)

(21) Appl. No.: 12/847,969

(22) Filed: Jul. 30, 2010

Related U.S. Application Data
(60) Provisional application No. 61/230,978, filed on Aug. 3, 2009.

(51) Int. Cl. G09G 5/10; F21V 7/22; B23P 11/00

(52) U.S. Cl. 345/690; 362/607; 362/617; 362/620; 29/428

(57) ABSTRACT

Various embodiments disclose an illumination apparatus. The apparatus may comprise a light guide supporting propagation of light and having at least a portion of one of its edges comprising an array of microstructures. These microstructures may be incorporated in the input window of the light guide to control the light intensity distributed within the light guide. In certain embodiments, the directional intensity of the light entering the light guide may be modified to achieve a desired distribution across the light guide.

### CROSS REFERENCE TO RELATED APPLICATION

This application claims the benefit of U.S. Application No. 61/230,978, filed Aug. 3, 2009, the entirety of which is incorporated by reference.

### BACKGROUND

1. Field of Invention

The present invention relates to microelectromechanical systems (MEMS) and more particularly to optical interference microstructures used to manipulate the light intensity profile within a light guide.

2. Description of Related Art

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

Certain embodiments contemplate an illumination apparatus comprising a light guide having a forward and rearward surface. The light guide further comprises a plurality of edges between the forward and rearward surfaces. The light guide comprises material that supports propagation of light along the length of the light guide. At least a portion of at least one of the edges comprises an array of microstructures, the microstructures comprising a plurality of prisms and a plurality of lenses.

In some embodiments, the illumination apparatus further comprises a plurality of gaps between different of the prisms and lenses, the gaps comprising flat surfaces parallel to the at least one of the edges. At least one of the prisms may comprise an asymmetric structure. The asymmetric structure may comprise first and second surfaces on the at least one edge that forms a right angle. The prisms may comprise cylindrical microstructures having first and second planar surfaces oriented at angles of about 90° with respect to each other as seen from a cross-section perpendicular to said at least one edge.

In some embodiments, the plurality of lenses comprise cylindrical lenses. In some embodiments the illumination apparatus comprises a plurality of the prisms included in a first periodic pattern in the array and a second plurality of lenses is included in a second periodic pattern in the array. In some embodiments, microstructures possessing substantially the same cross-section occur periodically in the array and are separated by microstructures having different cross-sections.

In some embodiments, microstructures possessing substantially the same size occur periodically in the array and are separated by microstructures having a different size. In some embodiments, microstructures possessing substantially the same spacing occur periodically in the array and are separated by microstructures having a different spacing. In some embodiments, the plurality of microstructures comprises a subset of microstructure that forms a pattern that is repeated. In some embodiments, the microstructures have a width between about 5 and 500 microns. In some embodiments, the microstructures have a height between about 0.1 and 3 mm.

In certain embodiments the microstructures have a spacing less than or equal to about 500 microns. The light guide may comprise a curve-shaped optical entrance window and said microstructures may be disposed on said curved optical entrance window. Some embodiments further comprise a light source disposed with respect to the light guide to inject light through the microstructure and into said light guide. In some embodiments, the microstructures are configured to receive light from a light source and expand the angular distribution of said light within the light guide relative to a flat optical surface on the light guide for receiving light from the light source not including said microstructures.

In some embodiments the microstructures are be configured to receive light from a light source and expand the angular distribution of said light within the light guide beyond an angle with respect to the normal that is in excess of the critical angle for said light guide. In some embodiments the critical angle for said light guide is at least 37 degrees. In some embodiments, the critical angle for said light guide is at least 42 degrees.

In some embodiments, the microstructures are configured to receive light from a light source and provide an angular distribution of said light within the light guide having a central peak disposed on a pedestal. In some embodiments the microstructures are configured to receive light from a light source and provide an angular distribution of light within the light guide having a decrease in on-axis brightness relative to larger angles. In some embodiments, the microstructures are be configured to receive light from a light source and provide an angular distribution of light within the light guide with substantially uniform fall-off from a central axis.

In certain embodiments the light source is a light emitting diode. In certain embodiments the light guide surface is disposed forward of a plurality of spatial light modulators to illuminate the plurality of said spatial light modulators. In some embodiments the plurality of spatial light modulators comprise an array of interferometric modulators. In some embodiments, the microstructures comprise a first larger set of features with a second smaller set of features located thereon. In some embodiments the first or second sets comprise planar portions. In certain embodiments the first or second sets of features comprise curved portions.

The first set of features may comprise curved portions and the second set may comprise planar portions. Alternatively the first set of features may comprise planar portions and the second set may comprises curved portions. In certain embodiments the first set of features may comprise lenses and the second set may comprise prismatic features or the first set of features may comprise prismatic features and the second set may comprise lenses. The microstructures may provide less than 10% nonuniformity in a viewing angle of +/−45°. In some embodiments, the microstructures provide less than 10% nonuniformity in a viewing angle of +/−60°. In some embodiments, the microstructures redirect light substantially via refraction rather than by reflection or diffraction.

In some embodiments, the illumination apparatus further comprises a display, a processor that is configured to communicate with said display, said processor being configured to process image data, and a memory device that is configured to communicate with said processor. The apparatus may further comprise a driver circuit configured to send at least one signal to the display. The apparatus may further comprise a controller configured to send at least a portion of the image data to the driver circuit. The apparatus may further comprise an image source module configured to send said image data to said processor. In some embodiments, the image source module comprises at least one of a receiver, transceiver, and transmitter. The apparatus may further comprise an input device configured to receive input data and to communicate said input data to said processor. In some embodiments the display comprises an array of interferometric modulators.

Certain embodiments contemplate an illumination apparatus comprising a light guide having a forward and rearward surface, the light guide further comprising a plurality of edges between the forward and rearward surfaces. The light guide comprises material that supports propagation of light along the length of the light guide. At least a portion of at least one of the edges comprises an array of microstructures. The microstructures comprise a first set of features located on each of a second set of features, each of the second set of features smaller than each of the first set of features. In some embodiments, the microstructures of at least one of the first and second sets comprise planar portions.

In some embodiments the microstructures of at least one of the first and second sets may comprise curved portions. In some embodiments, the first set of features comprises lenses and the second set of features comprises prisms. In some embodiments the first set of features comprises prisms and the second set of features comprises lenses.

Certain embodiments contemplate an illumination apparatus comprising means for guiding light having a forward and rearward surface. The light guiding means further comprises a plurality of edges between the forward and rearward surfaces, the light guiding means comprising material that supports propagation of light along the length of the light guiding means. At least a portion of at least one of the edges comprises an array of means for directing light. The light directing means comprises a plurality of first light directing means and a plurality of second light directing means. The first light directing means comprising angled planar surfaces and the second light directing means comprising curved surfaces.

In certain embodiments, the light guiding means comprises a light guide or the light directing means comprises microstructures, or the first light directing means comprises prisms, or the second light directing means comprises lenses.

Certain embodiments contemplate an illumination apparatus comprising means for guiding light having a forward and rearward surface. The light guiding means further comprises a plurality of edges between the forward and rearward surfaces. The light guiding means comprises material that supports propagation of light along the length of the light guiding means. At least a portion of at least one of the edges comprises an array of means for directing light, the light directing means comprising a first set of means for directing light on each of a second set of means for directing light. Each of the second set of light directing means may be smaller than each of the first set of light directing means.

In certain embodiments, the light guiding means comprises a light guide or the light directing means comprises microstructures or the first set of light directing means comprises a first set of microstructures or the second set of light directing means comprises a second set of microstructures.

Certain embodiments contemplate a method of manufacturing an illumination apparatus comprising providing a light guide having a forward and rearward surface, the light guide further comprising a plurality of edges between the forward and rearward surfaces. The light guide comprises material that supports propagation of light along the length of the light guide. The method of manufacturing further comprises forming an array of microstructures on at least a portion of at least one of the edges, the microstructures comprising a plurality of prisms and a plurality of lenses.

Certain embodiments contemplate a method of manufacturing an illumination apparatus comprising: providing a light guide having a forward and rearward surface, the light guide further comprising a plurality of edges between the forward and rearward surfaces, said light guide comprising material that supports propagation of light along the length of the light guide. The method of manufacturing further comprises forming an array of microstructures on at least a portion of at least one of the edges, the microstructures comprising a first set of features located on each of a second set of features, each of the second set of features smaller than each of the first set of features.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one example of an interferometric modulator of FIG. 1.

FIG. 4 is an illustration of a set of row and column voltages that may be used to drive an interferometric modulator display.

FIGS. 5A and 5B illustrate a timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a light source, such as an LED, with a convex curved output window.

FIG. 9 schematically illustrates one embodiment of the light source positioned relative to an edge of a light guide disposed forward of a spatial light modulator array.

FIG. 10 are plots on axes at relative luminescence versus degree of the directional intensity profile of light emitted from a light source measured in air and in a light guide such as is shown in FIGS. 8 and 9 respectively which is substantially flat.

FIG. 11 schematically illustrates an isometric perspective view of a planar light guide having an array of microstructures on a portion of at least one of its edges.

FIG. 12 schematically illustrates a top-down perspective view of the light source and planar light guide of FIG. 11 showing a semi-circle cross-section.

FIG. 13 is a plot on axis of directivity vs. θ of (i) the resulting directional intensity profile in a light guide for a light source coupled to an optical entrance window which is substantially flat, (ii) the resulting profile when a series of cylindrical micro structures with semi-circular cross-sections, without spacing between each other, are present at the coupling window, and (iii) the resulting profile when the semicircle shaped microstructures are spaced approximately 0.045 mm between one another.

FIG. 14 schematically illustrates the refraction angles resulting from light incident on a substantially planar microstructure surface.

FIG. 15 schematically illustrates the refraction angles resulting from light incident on a substantially convex microstructure surface.

FIG. 16 schematically illustrates an isometric perspective of an embodiment comprising 45° −90° −45° isosceles triangle saw tooth microstructures.

FIG. 17 is a plot of the directional intensity profile resulting from the microstructures of the embodiment of FIG. 16.

FIG. 18 schematically illustrates an isometric perspective of an embodiment wherein the sharpness of the saw tooth is reduced to yield trapezoidal microstructures.

FIG. 19 is a plot of the directional intensity profile resulting from the microstructures of the embodiment of FIG. 18.

FIG. 20 schematically illustrates an isometric perspective of an embodiment comprising both curved and trapezoidal microstructures in a repeating pattern.

FIG. 21 is a top-down view of the microstructures of the embodiment of FIG. 20.

FIG. 22 is a plot of the directional intensity profile resulting from the microstructures of the embodiment of FIG. 21.

FIG. 23 schematically illustrates an isometric perspective of an embodiment comprising both curved and asymmetric cross-section triangle microstructures.

FIG. 24 is a top-down view of the microstructures of the embodiment of FIG. 23.

FIG. 25 is a plot of the directional intensity profile resulting from the microstructures of the embodiment of FIG. 23.

FIG. 26 schematically illustrates a top-down view of yet another alternative embodiment of the light microstructures having a set of smaller features disposed on a set of larger features.

FIG. 27 schematically illustrates a top-down view of yet another alternative embodiment of the light microstructures having a set of smaller features disposed on a set of larger features.

FIG. 28 schematically illustrates yet another alternative embodiment of the light source positioned relative to a light guide having a concave recess lined with microstructures.

FIG. 29 is a top-down view of the light guide of the embodiment of FIG. 28.

### DETAILED DESCRIPTION OF THE PREFERRED EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

As discussed more fully below, in certain preferred embodiments means for directing light (i.e. microstructures) may be incorporated in the input window of a light guiding means (i.e. a light guide) to control the light intensity distributed within the light guide. In certain embodiments, the directional intensity of the light entering the light guide may be modified to achieve a more efficient distribution across the light guide. In some embodiments, the microstructures may comprise either curved means for directing light (i.e. lenses) or angled means for directing light (i.e., prisms). These microstructures serve to refract incoming light. In certain embodiments, microstructures disposed along at least one edge of the light guide redirect light from the light source to form a desired directional intensity profile within the light guide. These profiles can be chosen so as to more evenly distribute the light received by the display elements. To achieve a particular profile, the microstructures can take on variety of shapes in different embodiments. A few example cross-sections include generally curved, triangular (isosceles, equilateral, asymmetric), and semi-circular. In various embodiments microstructures of various shapes will be arrayed in patterns facilitating the creation of different light intensity profiles within the light guide. In some embodiments light passing through the light guide can then be redirected to pass into a plurality of display elements including one or more interferometric modulators.

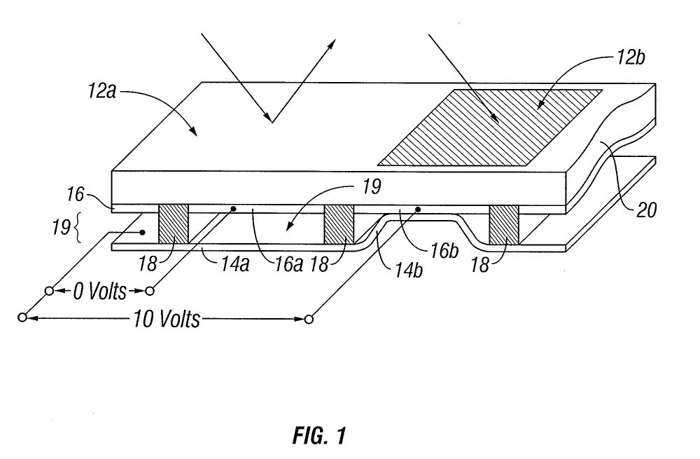

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and off' states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

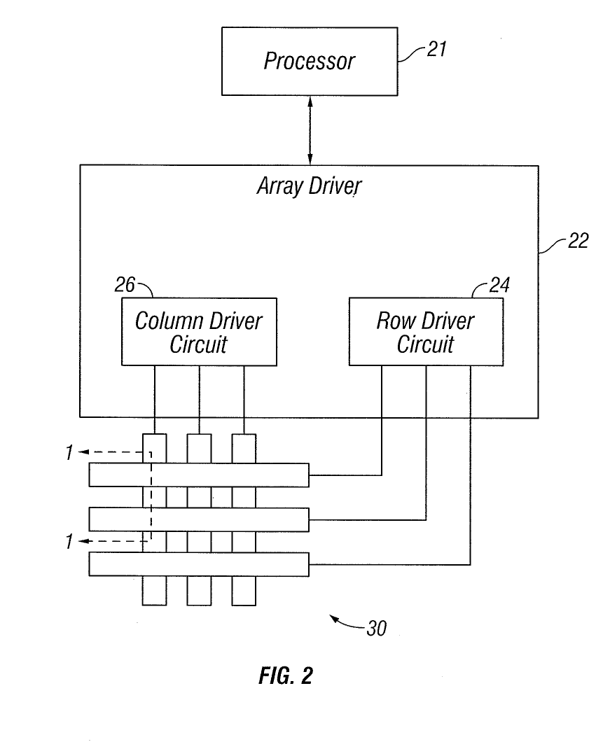

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

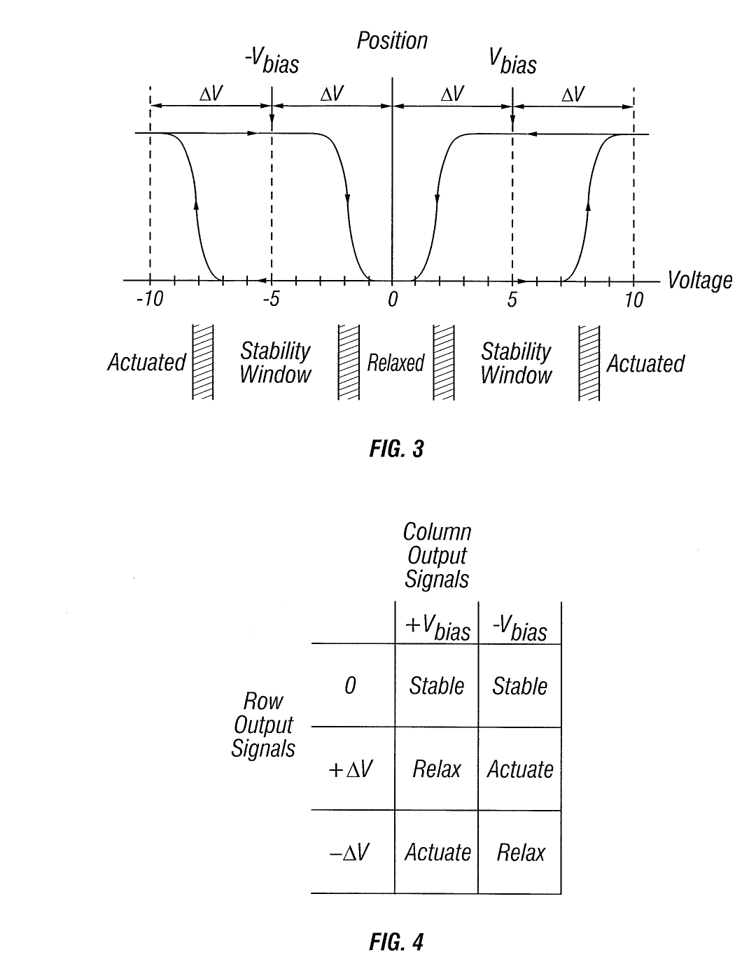

FIG. 3 is a diagram of movable mirror position versus applied voltage for one example of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the example of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

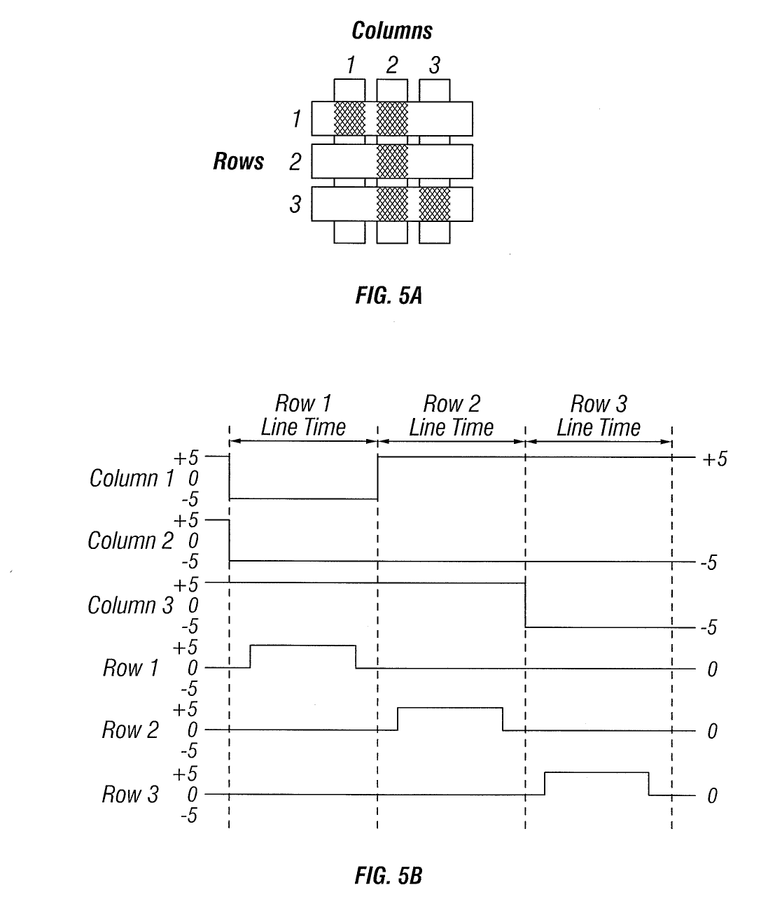

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

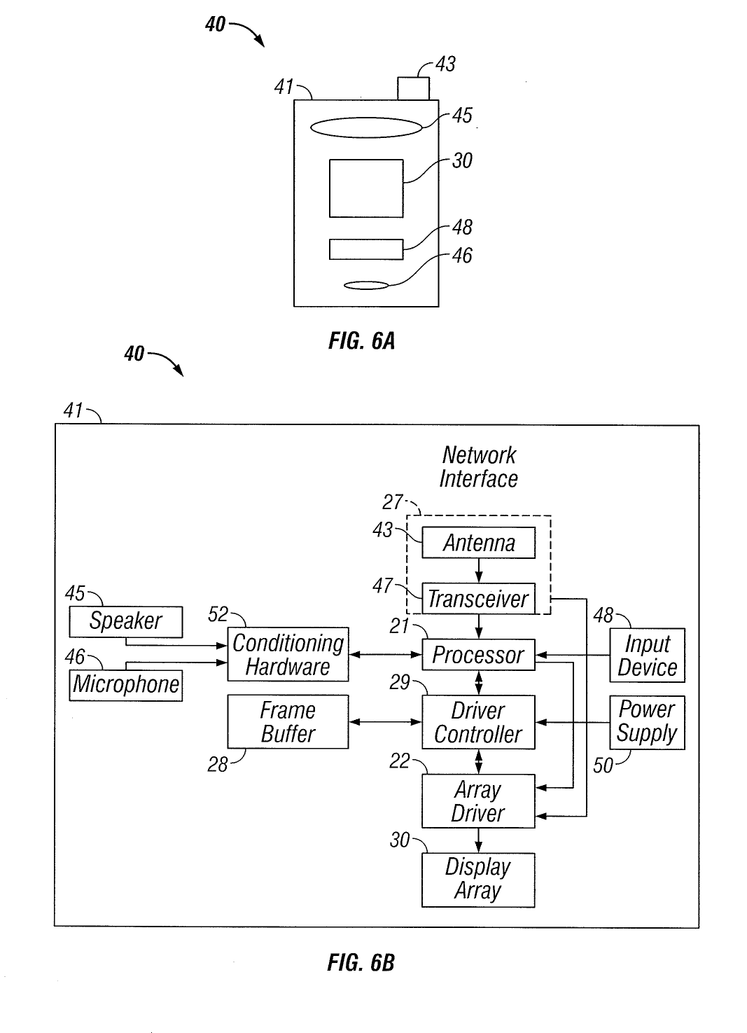

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment the display 30 includes an interferometric modulator display as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

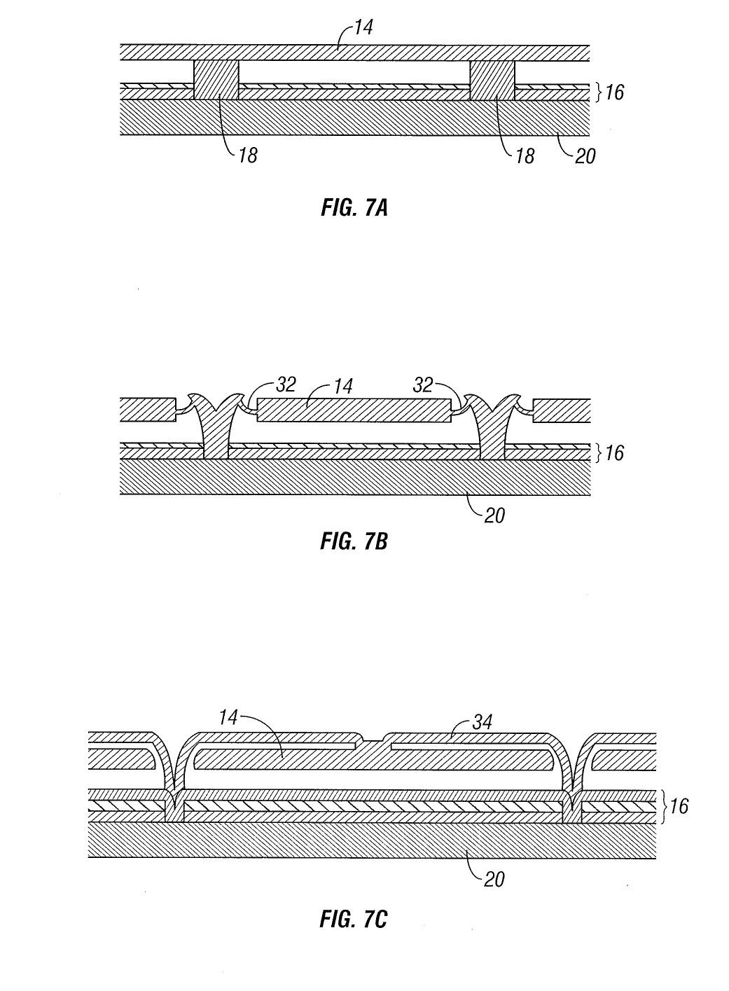

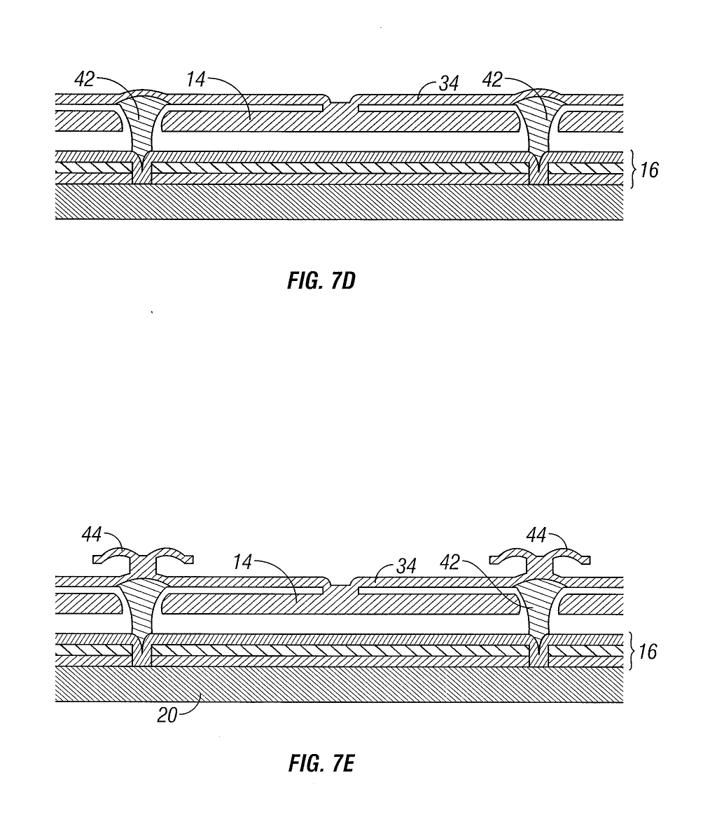

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As described above, the interferometric modulators are reflective display elements and in some embodiments may rely on ambient lighting or internal illumination for their operation. In some of these embodiments, an illumination source directs light into a light guide disposed forward of the display elements, from which light may thereafter be redirected into the display elements. The distribution of light within the light guide will determine the angular distribution or uniform brightness of the light display elements. If the light within the light guide has a narrow directional intensity profile, it may produce dark corners within the light guide and consequently poor illumination of the display elements. Thus, it would be advantageous to control the directional intensity profile of the light directed into the light guide.

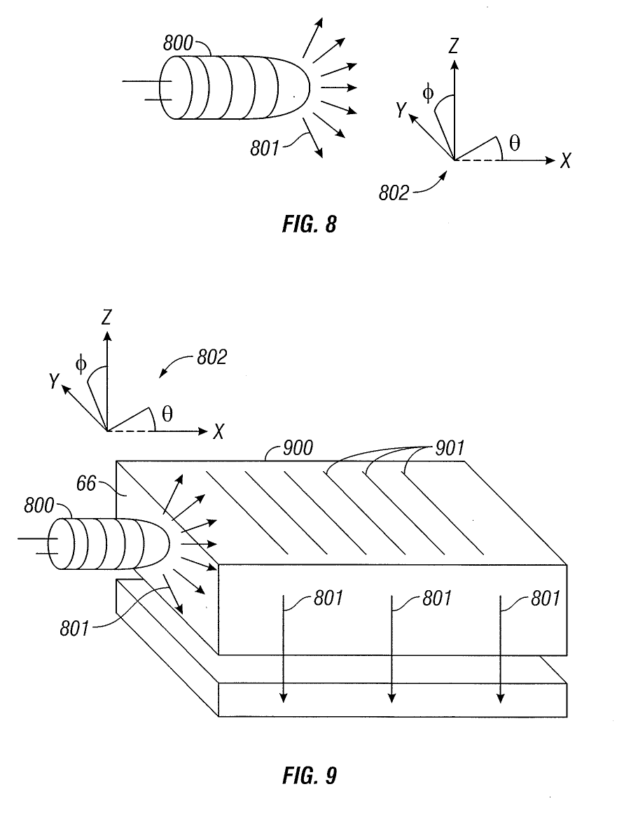

FIG. 8 illustrates a light source emitter 800 in free space. A coordinate system 802 is also shown in relation to the orientation coordinates of the display device. In other embodiments the light source 800 may be a light emitting device such as, but not limited to, one or more light emitting diodes (LED), a light bar, one or more lasers, or any other form of light emitter. The convex output surface on the bullet package of the light source provides a narrowed light distribution.

FIG. 9 illustrates an isometric view of light source 800 disposed at the edge of light guide 900. The light guide 900 may comprise optically transmissive material e.g., glass or plastic. Light transmitted through light guide edge 66 will be redirected within the light guide 900 towards display elements 901, which will then reflect the light 801. The light passing through light guide 900 would preferably reach as many of the display elements 901 as possible. The directional intensity profile within the light guide affects how much light is available to each of the display elements. The interface at edge 66 between the light guide 900 and light source 800 contributes significantly to the resulting directional profile throughout the light guide. The light source 800 can be disposed in one corner of the light guide, but in various embodiments, may be located at the center of curvature of the concentric curved paths comprising turning features. In some embodiments, the light source 800 may be disposed along one or more edges of the light guide.

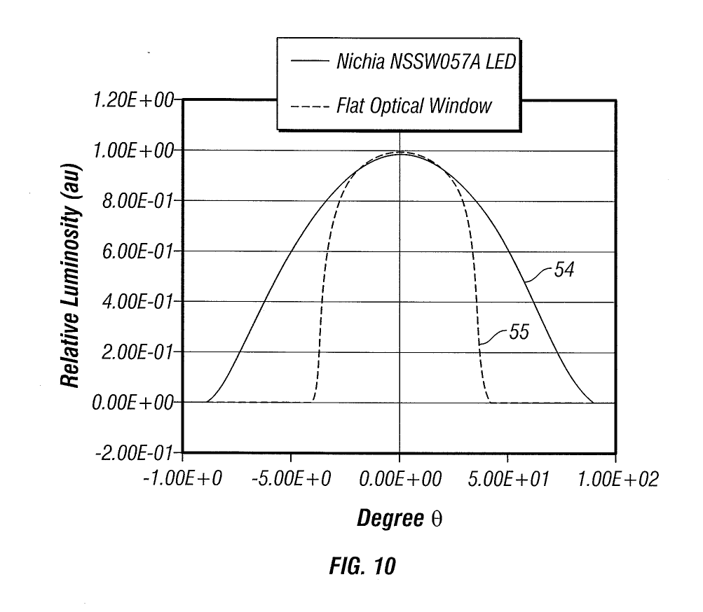

To demonstrate the effect of the interface on the resulting directional intensity profile in the plane of the light guide, FIG. 10 illustrates a plot of the computed distribution directional intensity profile 54 for an LED light source in open air, and a directional intensity profile 55 for an LED disposed at the edge of a light guide. As can be seen, the directional intensity profile 55 in the optical medium 900 is narrower than the resulting profile 54 when light passes through the air. The narrower directional profile can result in dark corners within the light guide which may provide insufficient light to the display elements and unevenness. Normally, for an LED emitting light in +/−90 deg (measured from normal to surface, e.g., surface 66 and the x direction of FIG. 9), the light distribution inside the light guide is within +/− the total-internal-reflection (TIR) angle or critical angle for the light guide. For example, in certain polycarbonate light guides the critical angle or total internal reflection angle would be 37-39°, approximately 42° for glass, etc. (See, e.g. directional intensity profile 54 in FIG. 10) In various embodiments it would be desirable for the interface between the illumination source and the light guide medium to produce a directional intensity profile reducing dark corners and providing increased uniformity across the display elements.

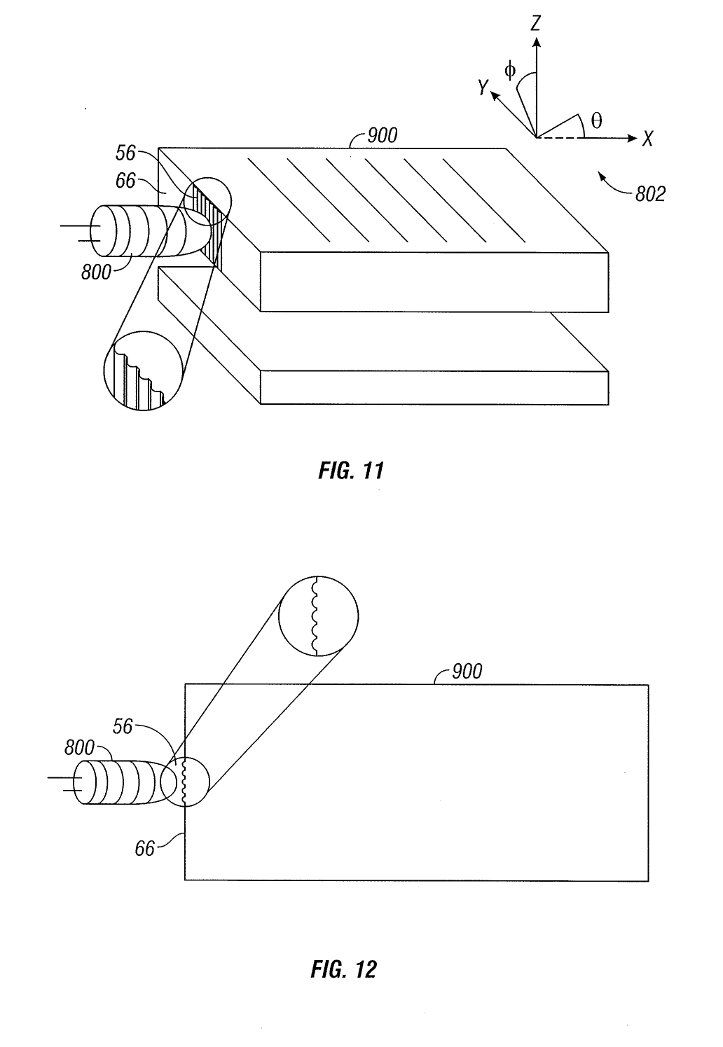

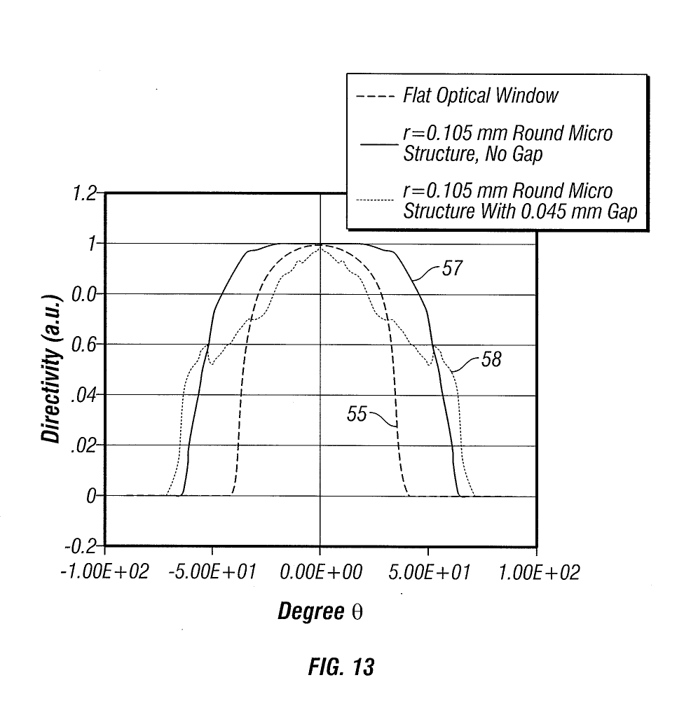

To advantageously achieve a variety of directional intensity profiles, certain embodiments of the invention, such as those shown in FIGS. 11 and 12, use an array of microstructures 56 disposed on at least a portion of the edge 66 of the light guide 900 facing the illumination source 800 so as to modify the directional intensity profile within the light guide. In some embodiments they modify the directional intensity profile primarily by refraction. Particularly, the microstructures may control the angular distribution of the light coupled inside the light guide from an illumination source 800 separated by an air gap from the input edge. Control may comprise expanding the angular range beyond the critical angle of the light guide, and the TIR limit (see, e.g., FIG. 10), increasing the intensity uniformity around the center axis (see, e.g., FIG. 13, curve 57), increasing the angle range beyond the critical angle of the light guide with decreased on-axis brightness (see, e.g., FIG. 19) or enhanced on-axis brightness (see, e.g., FIG. 13, curve 58), among many other possible modifications.

The microstructures can take on a variety of shapes in various embodiments, but are here shown (not to scale) as an array of partial right circular cylinders with semi-circular cross-section parallel to the y-z plane. These cylinders are more narrow toward the illumination source and have sloping sidewalls, whose slope changes so as to accept light from the illumination source at a variety of different angles. Although shown here as protruding from the edge 66, one skilled in the art will readily recognize that these and other microstructures of the various embodiments may be formed by recesses into the light guide 900 or by a combination of protrusions and recesses. By accepting the light at other than planar angles, broader and more expansive angular intensity profiles may be achieved. A variety of cross-sections are possible and may, for example, be triangular (e.g., isosceles, equilateral, asymmetric), generally circular, or trapezoidal. Although shown here as being cylindrical, one skilled in the art will recognize that the microstructures can take on a number of different structures and shapes to achieve various directional profiles. In certain embodiments, the microstructures have widths varying from 5 microns to 500 microns. In some embodiments, 5 microns corresponds to the typical dimensions of certain microfabrication techniques which may be used (e.g. diamond point turning of a flat surface—inscribing grooves—which is then used as a mold insert in an injection molding cavity to define the input edge of the lightguide). Although the size may be less than 500 microns in some embodiments, the microstructure size may exceed this value. In certain embodiments, the array of microstructures may be of similar size to the LED width (2-4 mm in certain instances), and thus each microstructure in the array may be a fraction of the array size. Similarly, the microstructures may take on a variety of heights, in certain embodiments ranging from 0.1 to the height (e.g. thickness) of the lightguide or LED. In some embodiments, the height of the microstructures is from 0.1 to 1 mm or 3 mm.

It is desirable to maintain angular uniformity when viewing the light guide 900 from above (that is, where the viewer looks down from the z direction). In particular, it is preferable to maintain angular uniformity in spite of different viewing angles φ. Although shown in the figures as the angle between Z and Y, one skilled in the art will readily recognize that φ may be chosen as any angle between Z and the X-Y Plane. For example, φ may indicate the angle between Z and X. Certain of the present embodiments are able to prevent substantial visible discontinuities (i.e. less than 5% or 10% nonuniformity) for φ within a range of +/−45° and others within a range of +/−60°.

To demonstrate the effectiveness of some of these embodiments, FIG. 13 illustrates a plot of the directional intensity profiles resulting from the application of illumination sources to light guides with different interfaces. For comparison, the resulting profile from a flat optical window, plot 55 of FIG. 10, is provided for reference. Plot 57 is of the directional intensity profile resulting from light passing through an array of curved microstructures of radius 0.105 mm without any space between them. Plot 58 is of the directional intensity profile resulting from light passing through an array of curved microstructures of radius 0.105 mm with a 0.045 mm space between each of them, measured from edge to edge. As can be seen, the plots 57 and 58 are broader and more efficient in their light distribution than is the plot 55 resulting from the planar interface. Furthermore, the distribution of plot 58 is more dynamic than the simple Gaussian-like distribution of plot 55. The angular distribution of plot 58 has a central peak disposed on a pedestal or a central peak surrounded by shoulders or side lobes on each side. By choosing not only the shape of the microstructure, but the spacing between them, one may advantageously provide a number of different profiles. In certain embodiments, the gap distance may range from zero to gaps comparable in dimension to the width of the microstructure. When the gap width is very much larger than the microstructure width, however, the input edge becomes substantially flat and the microstructures' effect is mitigated. In various embodiments, the (e.g. average) gap width is less than or equal to the (e.g. average) microstructure width. In certain embodiments, at least 50% of the input edge comprises microstructures. Thus, the microstructures advantageously facilitate not only broader intensity profiles, but also more control over the light distribution.

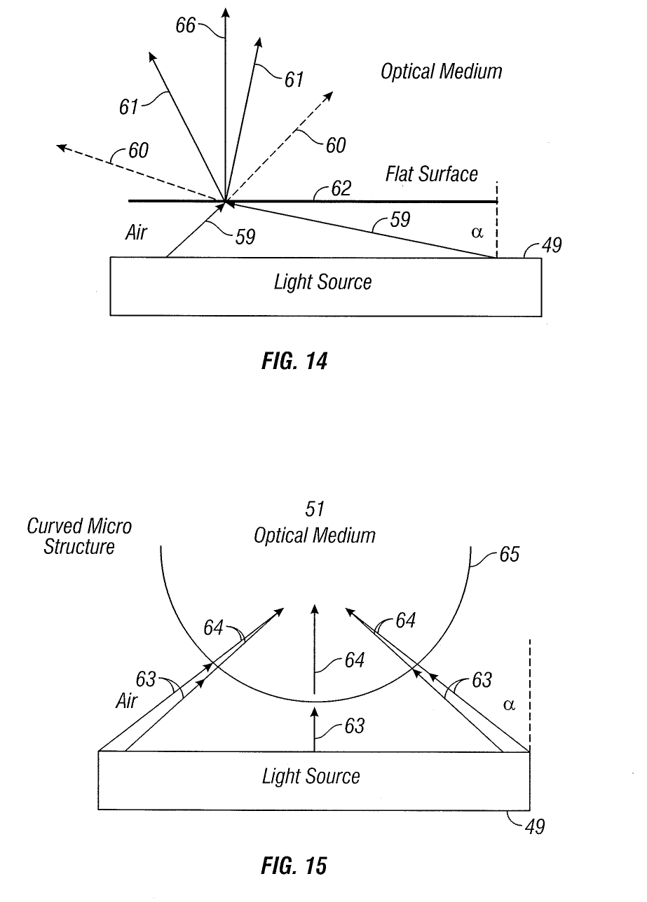

FIGS. 14 and 15 illustrate the principles by which the microstructures affect different light distributions. FIG. 14 depicts the effect of a flat interface between the planar light guide surface 62 and the light source 800. The light guide possesses a higher index of refraction from the surrounding medium. Emitted light rays 59 travel from the light source 800 and are refracted, as predicted by the principles of Snell's law, to become redirected light rays 61, following paths closer to normal 66, rather than continuing transmission through the light guide 62 as rays of the original direction 60. This results naturally from the differing refractive mediums between the light guide and the surrounding material.

FIG. 15, in contrast to the design FIG. 14, depicts how certain embodiments of the invention achieve an advantageously broader angular intensity profile. A curved interface 65, rather than a planar surface between air and the substantially transmissive medium of the light guide, permits incoming rays of light to maintain their direction of propagation upon passing through the interface. Emitted light rays 63, although still subjected to the effects of Snell's law, enter parallel to the normal to the curved interface 65 of the microstructure, and thereby continue as rays of the same direction 64. Thus, a significant number of rays that would otherwise have been redirected by a planar interface towards the normal 66, are now able to continue on a variety of wide angle directed paths. The presence of light rays pursuing wide angle paths results in a distribution that is much broader than can be achieved when passing through a planar interface.

Although FIG. 15 demonstrates the effect of embodiments implementing curve-shaped microstructure interfaces, for example having semi-circular shaped cross-section, one skilled in the art will readily recognize that a wide variety of shapes offering alternative path displacements are possible. For example, in addition to curve-shaped microstructures, other embodiments, including but not limited to triangular and trapezoidal, are possible. Designers requiring more degrees of freedom with which to tailor their directional profiles may use combined arrays having microstructures of two or more shapes present in a recurring pattern. The choice of shape, pattern, density and spacing between successive microstructures, as well as a variety of other parameters, can thus be modified to achieve a particular directional intensity profile. As mentioned previously, microstructures may both protrude from and intrude into the light guide.

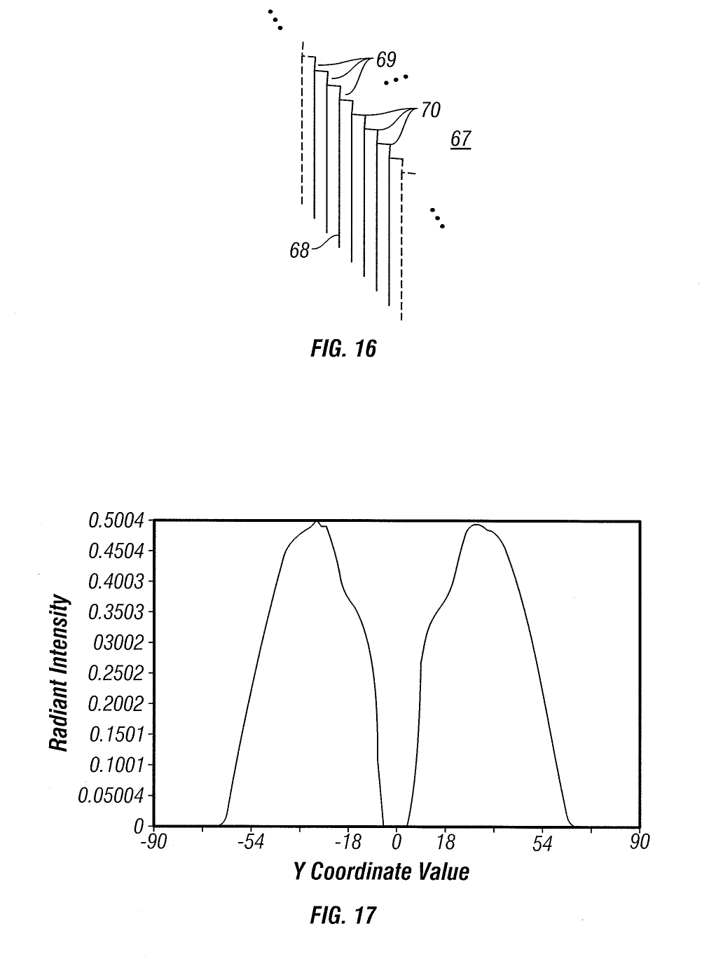

For example, FIG. 16 illustrates one embodiment of the triangular or sawtooth microstructure array 68. In this embodiment, individual microstructures 69 of light guide edge 67 take on isosceles triangle shapes. The space 70 between individual microstructures can be modified to achieve various directional intensity profiles. FIG. 17 plots the directional intensity profile resulting from the microstructure embodiment of FIG. 16.

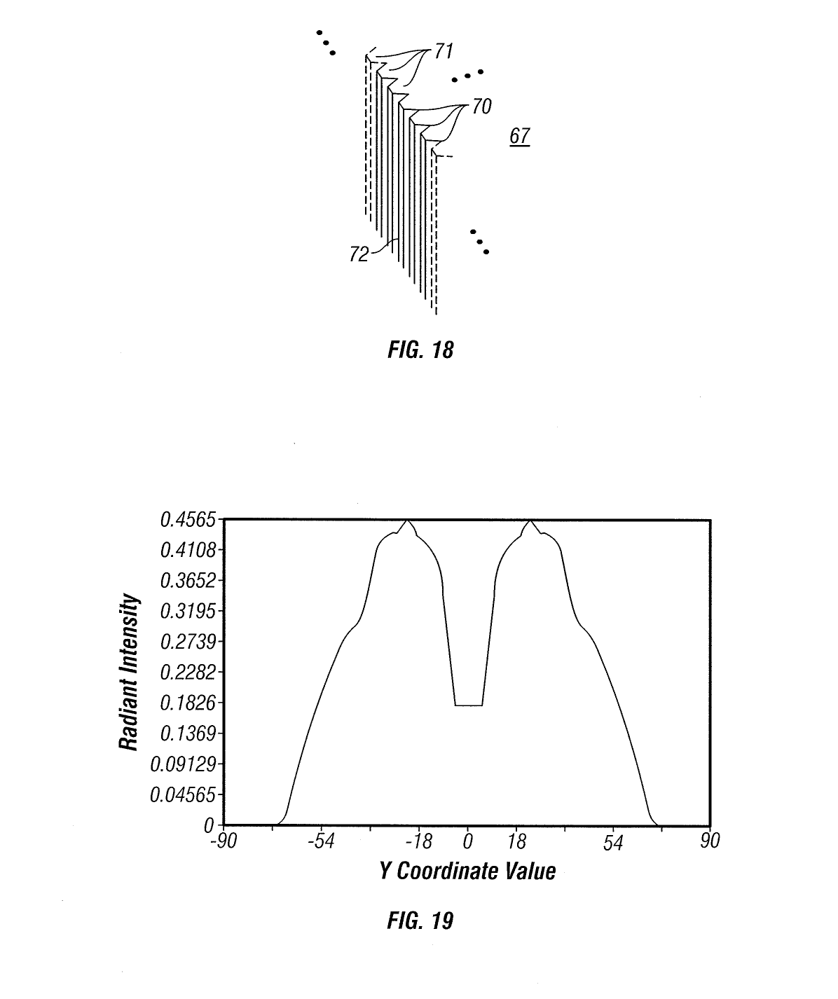

In yet another example, illustrated by FIG. 18, differing cross-sections are possible. The individual microstructures 71 of array 72 may take on a trapezoidal shape. Again, the space 70 can be varied to facilitate the creation of a variety of directional intensity profiles. FIG. 19 plots the directional intensity profile resulting from the microstructure embodiment of FIG. 18. As shown in FIG. 19, some microstructures may make the on-axis brightness smaller than the larger angles. FIG. 19 shows a distinct dip on-axis compared with other angles.

As discussed above, more control over the profile distribution can be achieved by combining different shaped microstructures into a single array. Not only the choice of shapes, but the manner in which they are arranged on the light guide edge will determine the resulting profile.

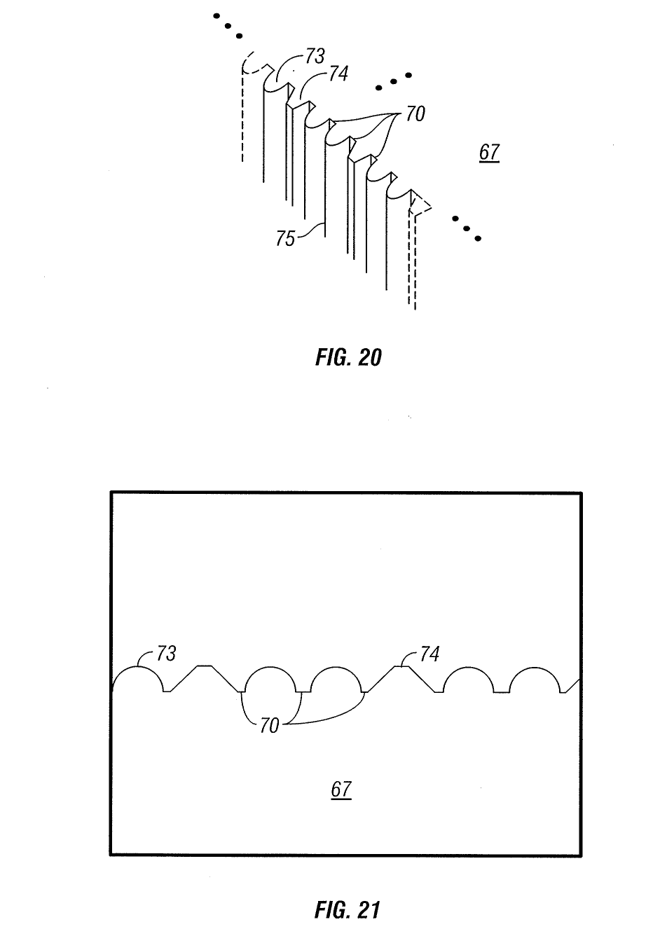

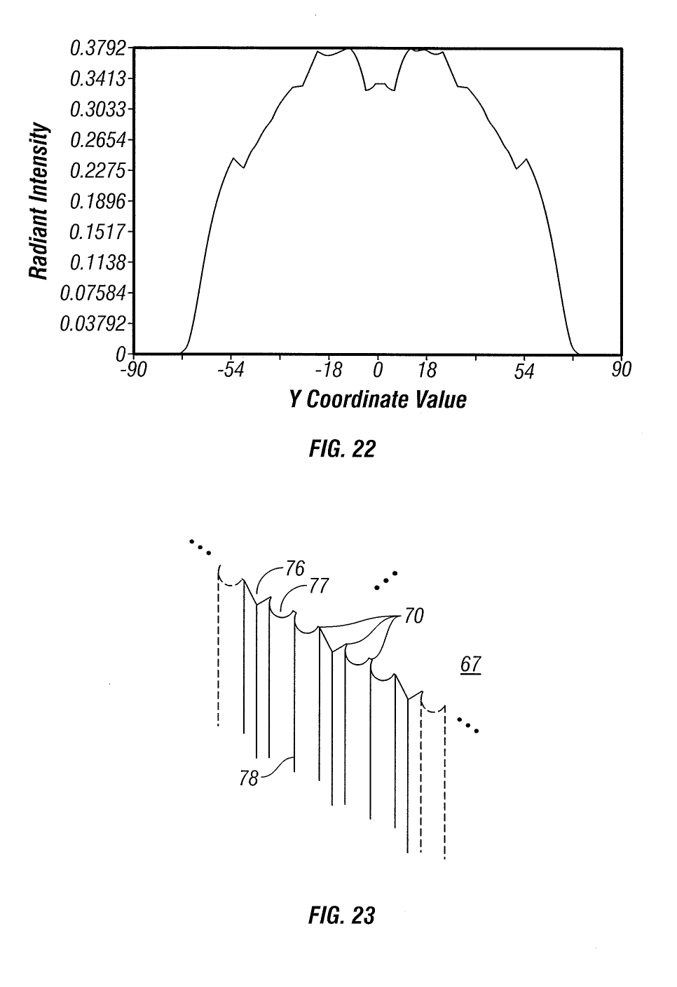

For example, FIG. 20 illustrates yet another embodiment, wherein the array 75 is comprised of microstructures having curved 73 shape and/or trapezoidal 74 shapes. As illustrated in FIG. 21, microstructures of a particular shape can be alternated as part of a pattern to achieve the desired directional light intensity profile. Size and shape can be varied throughout the array to achieve different types of profiles. FIG. 22 plots the resulting directional intensity profile for the array of FIG. 20.

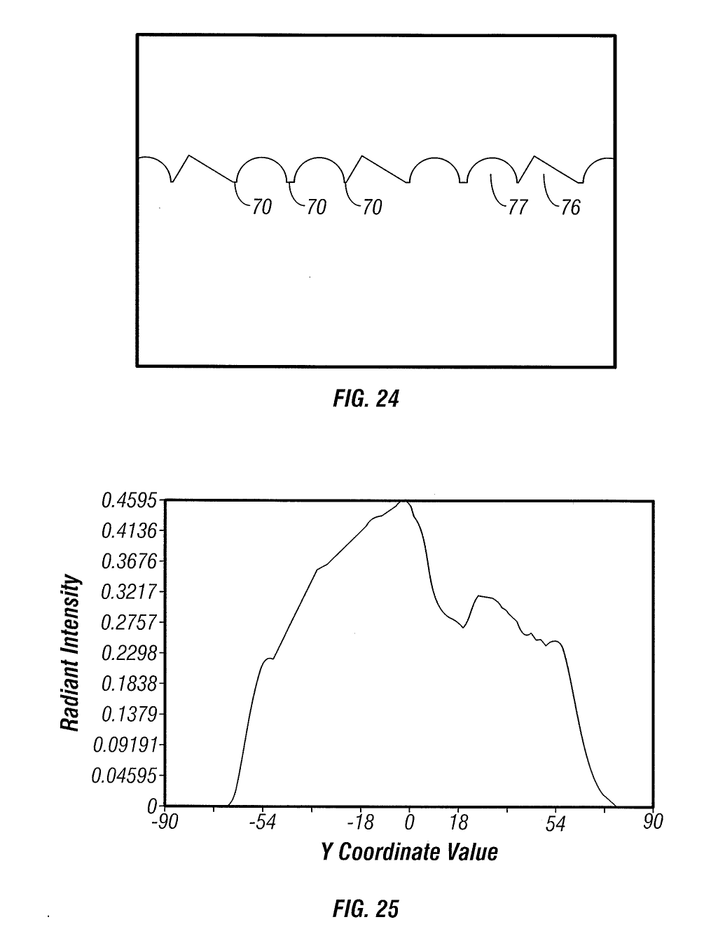

The examples so far disclosed have each produced symmetric intensity profiles as seen in FIGS. 17, 19, and 22. One may also produce various asymmetric profiles by properly selecting the choice of microstructure shape, spacing, and patterning. For example, in yet another embodiment illustrated in FIG. 23, the array 78 comprises asymmetric triangular microstructures 76 and curved microstructures 77. The triangular microstructures, as shown here, could be 30°−90−60° triangles. These particular shapes can be arranged in the pattern shown in FIG. 24, to achieve an asymmetric directional light intensity profile. FIG. 25 plots an intensity profile resulting from such a pattern, wherein the curved microstructures have a radius of 0.105 mm and the triangular microstructures have a triangle height of 0.105 mm.

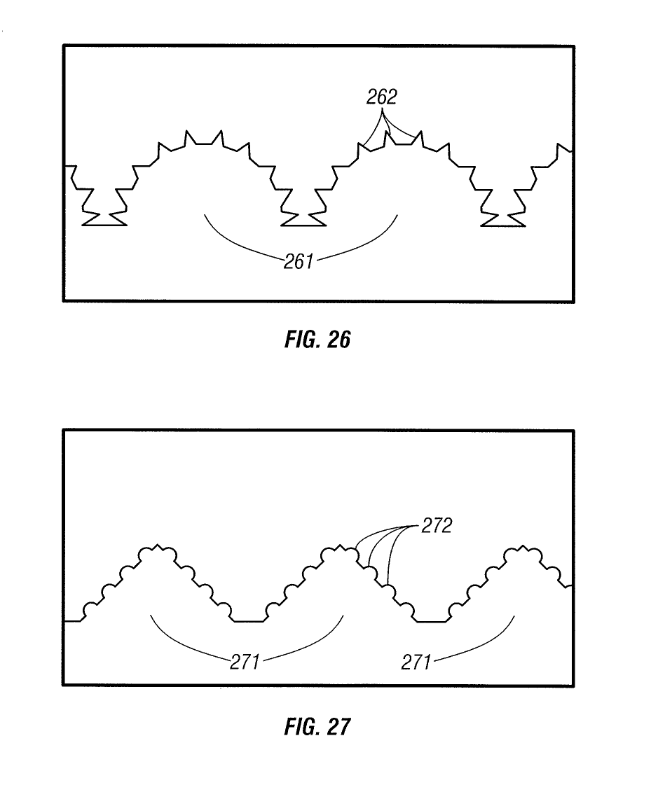

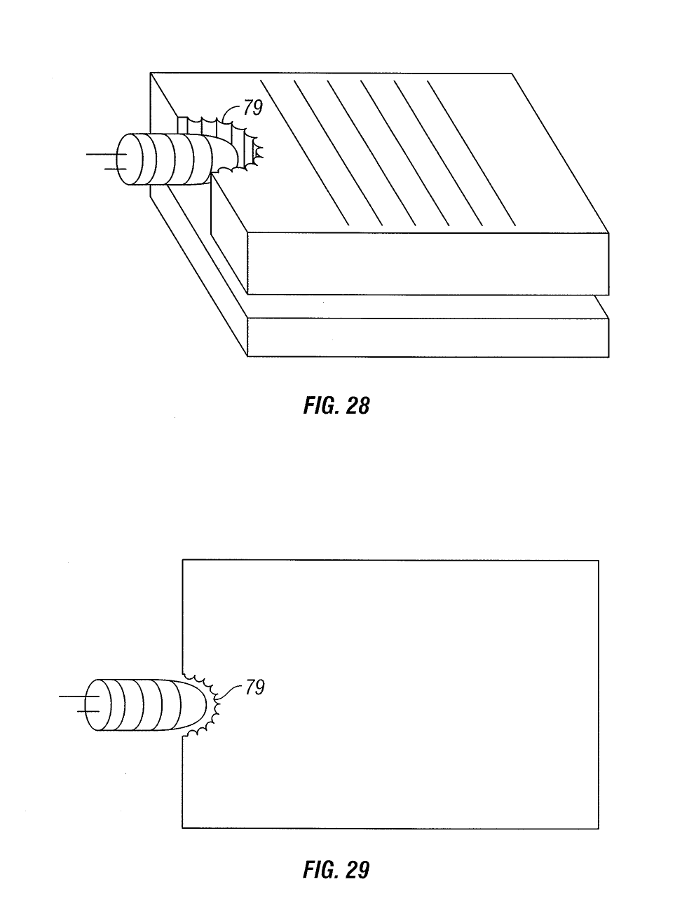

In addition to the various embodiments disclosed above, FIGS. 26 and 27 illustrate further embodiments wherein a first set of larger microstructures 261 has a second set of smaller microstructures 262 superimposed thereon. For example, FIG. 26 shows a first set of microstructures 261 comprising a larger curved base (e.g., having a substantially semicircular cross-section) and a second set of smaller faceted microstructures 262 disposed upon the first set of microstructure. The larger generally curved structures 262 may comprise curved lenslets having prismatic features, for example, disposed thereon. The prisms and the lenses may, for example, be cylindrical. The prismatic features 262 are shown have two sloping planar surfaces that meet at an apex of the prism. In other embodiments, the sets of features may have different sizes, shapes, density, or may otherwise vary. Prisms, for example, having more surfaces may be used or different angles therebetween. Additionally, the prismatic features may be larger or smaller. Similarly, the lenses may be larger or smaller and shaped differently and may be, for example, convex or concave. Other shapes, sizes, and configurations are possible. The features in a set may vary (e.g., periodically or aperiodically) as discussed above with respect to FIGS. 20-25. Thus, a wide variety of arrangements are possible.

FIG. 27 shows another embodiment wherein the relationship is inverted, that is a first set of structures 271 is generally faceted and a second set of features 272, which is curved, is disposed thereon. In other embodiments, both the first and second sets may be prisms or both the first and second sets may be lenses. Additional sets (e.g., 2, 3, 4 sets) may be disposed atop one another and various combinations of shapes may be selected. The shapes may be different from the faceted and curved shapes shown. For example, although shown here as being convex, the features may comprise concave features; thus protrusions or indentions or combinations thereof are possible. Moreover, the different types of embodiments described elsewhere in this application may be used in conjunction with superposing one set of microstructures on another. Likewise, any of the sets may include the various characteristics described herein including but not limited to shape, sizes, spacing, pattern, arrangement etc.

One skilled in the art will readily recognize that the designs disclosed above can be variously modified and may alter the distribution of the directional profile. For example, FIGS. 26 and 27 illustrate other certain embodiments wherein a concave coupling window 79 permits the partial insertion of the illumination source 800 having a convex curved output window into the light guide.

While certain embodiments of the disclosure have been described, these embodiments have been presented by way of example only, and are not intended to limit the scope of the present inventions. A wide variety of alternative configurations are also possible. For example, components (e.g., layers) may be added, removed, or rearranged. Similarly, processing and method steps may be added, removed, or reordered.

Accordingly, although certain preferred embodiments and examples have been described above, it will be understood by those skilled in the art that the present invention extends beyond the specifically disclosed embodiments to other alternative embodiments and/or uses and obvious modifications and equivalents thereof. In addition, while several variations have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes and embodiments. Thus, it is intended that the scope of the present invention herein disclosed should not be limited by the particular disclosed embodiments described above.

What is claimed is:

1. An illumination apparatus comprising:
a light guide having a forward and rearward surface, the light guide further comprising a plurality of edges between the forward and rearward surfaces, said light guide comprising material that supports propagation of light along the length of the light guide; and
at least a portion of at least one of the edges comprising an array of microstructures, said microstructures comprising a plurality of prisms and a plurality of lenses.

2. The illumination apparatus of claim 1, further comprising a plurality of gaps between different of said prisms and lenses, said gaps comprising flat surfaces parallel to said at least one of the edges.

3. The illumination apparatus of claim 2, wherein at least one of the prisms comprises an asymmetric structure.

4. The illumination apparatus of claim 3, wherein said asymmetric structure comprises first and second surfaces on said at least one edge that forms a right angle.

5. The illumination apparatus of claim 3, wherein the prisms comprise cylindrical microstructures having first and second planar surfaces oriented at angles of about 90° with respect to each other as seen from a cross-section perpendicular to said at least one edge.

6. The illumination apparatus of claim 1, wherein the plurality of lenses comprise cylindrical lenses.

7. The illumination apparatus of claim 1, wherein a plurality of the prisms is included in a first periodic pattern in the array and a second plurality of lenses is included in a second periodic pattern in the array.

8. The illumination apparatus of claim 7, wherein microstructures possessing substantially the same cross-section occur periodically in the array and are separated by microstructures having different cross-sections.

9. The illumination apparatus of claim 1, wherein microstructures possessing substantially the same size occur periodically in the array and are separated by microstructures having a different size.

10. The illumination apparatus of claim 1, wherein microstructures possessing substantially the same spacing occur periodically in the array and are separated by microstructures having a different spacing.

11. The illumination apparatus of claim 1, wherein the plurality of microstructures comprises a subset of microstructure that forms a pattern that is repeated.

12. The illumination apparatus of claim 1, wherein the microstructures have a width between about 5 and 500 microns.

13. The illumination apparatus of claim 1, wherein the microstructures have a height between about 0.1 and 3 mm.

14. The illumination apparatus of claim 1, wherein the microstructures have a spacing less than or equal to about 500 microns.

15. The illumination apparatus of claim 1, wherein said light guide comprises a curve-shaped optical entrance window and said microstructures are disposed on said curved optical entrance window.

16. The illumination apparatus of claim 1, further comprising a light source disposed with respect to said light guide to inject light through said microstructure and into said light guide.

17. The illumination apparatus of claim 1, wherein the microstructures are configured to receive light from a light source and expand the angular distribution of said light within the light guide relative to a flat optical surface on the light guide for receiving light from the light source not including said microstructures.

18. The illumination apparatus of claim 1, wherein the microstructures are configured to receive light from a light source and expand the angular distribution of said light within the light guide beyond an angle with respect to the normal that is in excess of the critical angle for said light guide.

19. The illumination apparatus of claim 18, wherein said critical angle for said light guide is at least 37 degrees.

20. The illumination apparatus of claim 18, wherein said critical angle for said light guide is at least 42 degrees.

21. The illumination apparatus of claim 1, wherein the microstructures are configured to receive light from a light source and provide an angular distribution of said light within the light guide having a central peak disposed on a pedestal.

22. The illumination apparatus of claim 1, wherein the microstructures are configured to receive light from a light source and provide an angular distribution of light within the light guide having a decrease in on-axis brightness relative to larger angles.

23. The illumination apparatus of claim 1, wherein the microstructures are configured to receive light from a light source and provide an angular distribution of light within the light guide with substantially uniform fall-off from a central axis.

24. The illumination apparatus of claim 16, wherein the light source is a light emitting diode.

25. The illumination apparatus of claim 1, wherein the light guide surface is disposed forward of a plurality of spatial light modulators to illuminate the plurality of said spatial light modulators.

26. The illumination apparatus of claim 25, wherein the plurality of spatial light modulators comprises an array of interferometric modulators.

27. The illumination apparatus of claim 1, wherein the microstructures comprise a first larger set of features with a second smaller set of features located thereon.

28. The illumination apparatus of claim 27, wherein the first or second sets comprises planar portions.

29. The illumination apparatus of claim 27, wherein the first or second sets of features comprises curved portions.

30. The illumination apparatus of claim 27, wherein the first set of features comprises curved portions and the second set comprises planar portions or the first sets of features comprises planar portions and the second set comprises curved portions.

31. The illumination apparatus of claim 27, wherein the first sets of features comprises lenses and the second set comprises prismatic features or the first sets of features comprises prismatic features and the second set comprises lenses.

32. The illumination apparatus of claim 1, wherein the microstructures provide less than 10% nonuniformity in a viewing angle of +/−45°.

33. The illumination apparatus of claim 1, wherein the microstructures provide less than 10% nonuniformity in a viewing angle of +/−60°.

34. The illumination apparatus of claim 1, wherein the microstructures redirect light substantially via refraction rather than by reflection or diffraction.

35. The illumination apparatus of claim 1, further comprising:
a display;
a processor that is configured to communicate with said display, said processor being configured to process image data; and
a memory device that is configured to communicate with said processor.

36. The apparatus of claim 35, further comprising a driver circuit configured to send at least one signal to the display.

37. The apparatus of claim 36, further comprising a controller configured to send at least a portion of the image data to the driver circuit.

38. The apparatus of claim 35, further comprising an image source module configured to send said image data to said processor.

39. The apparatus of claim 38, wherein the image source module comprises at least one of a receiver, transceiver, and transmitter.

40. The apparatus of claim 35, further comprising an input device configured to receive input data and to communicate said input data to said processor.

41. The apparatus of claim 35, wherein said display comprises an array of interferometric modulators.

42. An illumination apparatus comprising:
a light guide having a forward and rearward surface, the light guide further comprising a plurality of edges between the forward and rearward surfaces, said light guide comprising material that supports propagation of light along the length of the light guide; and
at least a portion of at least one of the edges comprising an array of microstructures, said microstructures comprising a first set of features located on each of a second set of features, each of the second set of features smaller than each of the first set of features.

43. The illumination apparatus of claim 42, wherein the microstructures of at least one of the first and second sets comprise planar portions.

44. The illumination apparatus of claim 42, wherein the microstructures of at least one of the first and second sets comprise curved portions.

45. The illumination apparatus of claim 42, wherein the first set of features comprises lenses and the second set of features comprises prisms.

46. The illumination apparatus of claim 42, wherein the first set of features comprises prisms and the second set of features comprises lenses.

47. An illumination apparatus comprising:
means for guiding light having a forward and rearward surface, the light guiding means further comprising a plurality of edges between the forward and rearward surfaces, said light guiding means comprising material that supports propagation of light along the length of the light guiding means; and
at least a portion of at least one of the edges comprising an array of means for directing light, said light directing means comprising a plurality of first light directing means and a plurality of second light directing means, the first light directing means comprising angled planar surfaces and the second light directing means comprising curved surfaces.

48. The illumination apparatus of claim 47, wherein the light guiding means comprises a light guide or the light directing means comprises microstructures, or the first light directing means comprises prisms, or the second light directing means comprises lenses.

49. An illumination apparatus comprising:
means for guiding light having a forward and rearward surface, the light guiding means further comprising a plurality of edges between the forward and rearward surfaces, said light guiding means comprising material that supports propagation of light along the length of the light guiding means; and
at least a portion of at least one of the edges comprising an array of means for directing light, said light directing means comprising a first set of means for directing light on each of a second set of means for directing light, each of the second set of light directing means smaller than each of the first set of light directing means.

50. The illumination apparatus of claim 49, wherein the light guiding means comprises a light guide or the light directing means comprises microstructures or the first set of light directing means comprises a first set of microstructures or the second set of light directing means comprises a second set of microstructures.

51. A method of manufacturing an illumination apparatus comprising:
providing a light guide having a forward and rearward surface, the light guide further comprising a plurality of edges between the forward and rearward surfaces, said light guide comprising material that supports propagation of light along the length of the light guide; and
forming an array of microstructures on at least a portion of at least one of the edges, the microstructures comprising a plurality of prisms and a plurality of lenses.

52. A method of manufacturing an illumination apparatus comprising:
providing a light guide having a forward and rearward surface, the light guide further comprising a plurality of edges between the forward and rearward surfaces, said light guide comprising material that supports propagation of light along the length of the light guide; and
forming an array of microstructures on at least a portion of at least one of the edges, the microstructures comprising a first set of features located on each of a second set of features, each of the second set of features smaller than each of the first set of features.
